(19) United States
(12) Patent Application Publication
(10) Pub. No.: US 2026/0077719 A1
(43) Pub. Date: Mar. 19, 2026

(54) STORABLE LADDER ASSEMBLY AND METHODS OF USE

(71) Applicant: Hyundai Translead, San Diego, CA (US)

(72) Inventors: Manuel Medina Morales, Tijuana (MX); Joel Maldonado Contreras, Tijuana (MX)

(21) Appl. No.: 19/329,120

(22) Filed: Sep. 15, 2025

Related U.S. Application Data
(60) Provisional application No. 63/768,934, filed on Mar. 8, 2025.
(60) Provisional application No. 63/696,807, filed on Sep. 19, 2024.

(51) Int. Cl. B60R 3/02

(52) U.S. Cl. CPC B60R 3/02

(57) ABSTRACT

A storable ladder assembly configured to attach to an underside of a platform and transition between a stored state and a deployed state is provided. In one aspect, the storable ladder includes a support frame, a step frame, a ladder frame, and a handrail. The step frame is configured to reversibly slide in a plane of the support frame. The step frame includes a left step side rail, a right step side rail, and a step between the left step side rail and the right step side rail. The ladder frame includes a pivot beam configured to reversibly slide in a plane of the support frame. The pivot beam is further configured to rotate relative to the plane of the support frame. The handrail is configured to rotate relative to the ladder frame between a stored state and a deployed state. The handrail includes a slotted opening configured to rotate about and translate relative to a connection element received in the ladder frame.

### INCORPORATION BY REFERENCE TO ANY PRIORITY APPLICATIONS

This application claims the benefit of U.S. Provisional Application No. 63/696807, filed September 19, 2024 and U.S. Provisional Application No. 63/768934, filed March 8, 2025, which are hereby incorporated by reference in their entirety.

### BACKGROUND

### Field

The present technology relates to a storable ladder assembly and methods of using a storable ladder assembly.

### Description of the Related Art

Ladders can aid in safely climbing onto and off of raised platforms. These ladders can be used across various industries to allow for safe access to raised platforms.

### SUMMARY

The embodiments disclosed herein each have several aspects, no single one of which is solely responsible for the present disclosure’s desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing systems and methods related to storable ladders.

In one aspect, a storable ladder assembly configured to attach to an underside of a platform and transition between a stored state and a deployed state is provided. The storable ladder assembly includes a support frame, a step frame, and a ladder frame. The support frame includes a left support side rail including a c-shaped channel, a right support side rail including a c-shaped channel, and a front rail attached at a left end to the left support side rail and at a right end to the right support side rail. The step frame is configured to reversibly slide in the c-shaped channels of the support frame. The step frame includes a left step side rail including a c-shaped channel, a right step side rail including a c-shaped channel, and a step between the left step side rail and the right step side rail. The ladder frame includes a left ladder side rail, a right ladder side rail, a pivot beam rotatably attached to the step frame and configured to reversibly slide in the c-shaped channels of the step frame, and one or more steps positioned between the left ladder side rail and the right ladder side rail.

In some embodiments, the storable ladder assembly also includes a left handrail and a right handrail pivotally attached to the ladder frame and configured to pivot between a stored state and a deployed state. The left handrail includes a slotted opening configured to rotate about a connection element received in the left ladder side rail. The right handrail includes a slotted opening configured to rotate about a connection element received in the right ladder side rail.

In some embodiments, when the right handrail is in the deployed state, a forwardmost surface of the right handrail is configured to contact a stop on the right ladder side rail, the stop configured to prevent clockwise and counterclockwise rotation of the right handrail.

In some embodiments, the right handrail is configured to pivot from the deployed state to the stored state by moving the slotted opening of the right handrail upward relative to the connection element received in the right ladder side rail to a position where a lowermost surface of right handrail is above the stop on the right ladder side rail, and rotating the right handrail parallel with the right ladder side rail.

In some embodiments, when the storable ladder assembly is in the stored state, the left handrail is received in the c-shaped channel of the left step side rail and the right handrail is received in the c-shaped channel of the right step side rail.

In some embodiments, when the storable ladder assembly is in the stored state, the step frame is nested within the support frame and the ladder frame is nested within the step frame.

In some embodiments, when the storable ladder assembly is in the deployed state, a rear end of the step frame is positioned rearward of a rear end of the support frame and the ladder frame is positioned at an angle relative to a longitudinal axis of the storable ladder assembly.

In some embodiments, when the storable ladder assembly is in the deployed state, each of the one or more steps of the ladder frame includes a flat surface that is parallel to the step of the step frame.

In some embodiments, the step frame includes a step stability rail support attached between a bottom side of the left step side rail and a bottom side of the right step side rail at a rear end of the step frame. When the storable ladder is in a deployed state, a front surface of the left ladder side rail and a front surface of the right ladder side rail contact a rear surface of the step stability rail support.

In some embodiments, the ladder frame includes a left handrail support positioned on an outside surface of the left ladder side rail and a right handrail support positioned on an outside surface of the right ladder side rail. The left handrail support and the right handrail support are configured to support the left and right handrails, respectively, when the storable ladder assembly is in the stored state.

In some embodiments, the storable ladder assembly includes a left handrail pivotally attached to the ladder frame and configured to pivot between a stored state and a deployed state. The step frame includes a left step frame through-hole at a rear end of the step frame. The left handrail includes a first left handrail through-hole a distance away from the first end of the left handrail. In a deployed state a first lock pin can extend through the left step frame through-hole and the first left handrail through-hole, thereby locking the left handrail in a deployed position and locking the ladder frame at a defined angle relative to the step frame.

In another aspect, a storable ladder is provided. The storable ladder includes a support frame, a step frame, and a ladder frame. The storable ladder can also include one or more handrails. The support frame includes a left support side rail and a right support side rail forming a plane. The step frame is configured to reversibly slide in the plane of the support frame between the left support side rail and the right support rail. The step frame includes a left step side rail, a right step side rail, and a step between the left step side rail and the right step side rail. The ladder frame includes a pivot beam configured to reversibly slide in the plane of the support frame between the left step side rail and the right step side rail of the step frame. The pivot beam is further configured to rotate relative to the plane of the support frame. The ladder frame further includes a left ladder side rail, a right ladder side rail, and one or more steps positioned between the left ladder side rail and the right ladder side rail. The one or more handrails are configured to rotate relative to the ladder frame between a stored state and a deployed state. The one more handrails include a slotted opening configured to rotate about and translate relative to a connection element received in the ladder frame.

In some embodiments, the one or more handrails includes a left handrail configured to translate along a longitudinal axis of the slotted opening between a first position relative to a left connection element received in the left ladder side rail and a second position relative to the left connection element. When the left handrail is in the first position, a forwardmost surface of the left handrail is configured to contact a stop on the left ladder side rail, the stop configured to prevent clockwise and counterclockwise rotation of the left handrail.

In some embodiments, the stop includes a triangular plate.

In some embodiments, when the left handrail is in the second position, a lowermost surface of the left handrail is above the stop such that the left handrail can pivot relative to the ladder frame.

In some embodiments, the one or more handrails includes a right handrail configured to translate along a longitudinal axis of the slotted opening between a first position relative to a right connection element received in the right ladder side rail and a second position relative to the right connection element. When the right handrail is in the first position, a forwardmost surface of the right handrail is configured to contact a stop on the right ladder side rail, the stop configured to prevent clockwise and counterclockwise rotation of the right handrail.

In some embodiments, the step frame includes a step stability rail support attached between a bottom side of the left step side rail and a bottom side of the right step side rail at a rear end of the step frame. When the storable ladder is in a deployed state, a front surface of the left ladder side rail and a front surface of the right ladder side rail contact a rear surface of the step stability rail support.

In some embodiments, the storable ladder includes a left attachment bracket attached to the left support side rail and a right attachment bracket attached to the right support side rail. The left and right attachment brackets are configured to mount the storable ladder to the underside of a vehicle.

In some embodiments, the storable ladder includes a handle positioned at the rear end of the ladder frame.

In another aspect, a kit is provided. The kit can include a storable ladder of any of the above-described embodiments and a latch configured to secure the storable ladder in the stored state.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates an embodiment of a storable ladder assembly according to the present disclosure in a deployed state.

FIG. 2 illustrates the storable ladder assembly of FIG. 1 in a stored state.

FIG. 3 illustrates deployment of a storable ladder assembly from a stored state to a deployed state in accordance with an embodiment of the present disclosure.

FIGS. 4A- 4C illustrate perspective views of an embodiment of a storable ladder assembly according to the present disclosure.

FIG. 5 illustrates top, side, detailed section, and exploded views of various components of the storable ladder assembly of FIG. 1 according to the present disclosure.

FIG. 6 illustrates a perspective view of an embodiment of a storable ladder assembly according to the present disclosure in a deployed state.

FIG. 7 illustrates a detailed view of a handrail of the storable ladder assembly of FIG. 6 according to an embodiment the present disclosure.

FIG. 8 illustrates a perspective view of the storable ladder assembly of FIG. 6 attached to a flatbed trailer in a stored state according to an embodiment of the present disclosure.

FIG. 9 illustrates top, side, detailed section, and exploded views of various components of the storable ladder assembly of FIG. 6 according to an embodiment of the present disclosure.

### DETAILED DESCRIPTION

The ladder assemblies described herein can be provided on a variety of platforms, such as vehicles or structures connected to vehicles. For example, the ladder assemblies described herein can be attached to a platform, such as but not limited to a flatbed of a trailer. Embodiments of the ladder assemblies according to the present disclosure can advantageously be compact, robust, and transitioned between stored and deployed configurations. Embodiments of the ladder assemblies according to the present disclosure can be advantageously retrofitted or installed on the aft portion of a frame of a flatbed of a trailer with few or no modifications to the frame. Devices, systems, and methods described herein can improve the ease and safety of climbing onto a platform, such as a flatbed. Advantageously, embodiments of the ladder assembly and methods according to the present disclosure are configured to be attached to and storable under a frame of a flatbed of a truck or trailer without taking up storage capacity or surface area on an upper surface of the flatbed. Advantageously, embodiments of the ladder assembly and methods described herein are compatible with both fixed and sliding type suspensions. The ladder assembly can advantageously be used in conjunction with flatbeds that include a toolbox or other storage compartment. For example, embodiments of the ladder assembly according to the present disclosure can be provided above a toolbox or other storage compartment at the aft end of a flatbed, without interfering with access to and use of the toolbox when the ladder assembly is in a stowed state (for example, a stored state).

Although embodiments of the present disclosure are described with reference to a ladder assembly provided on a flatbed of a truck or trailer, it will be understood that ladder assemblies according to the present disclosure can be suitably implemented on many different platforms, including but not limited to storage containers, fixed structures such as stages, and vehicles (for example watercraft, recreational vehicles, trucks, and construction vehicles). It will also be understood that ladder assemblies according to the present disclosure need not be provided on the aft or rear end of a vehicle and can be provided in any suitable location of a platform. It will also be understood that ladder assemblies according to the present disclosure need not be provided on or attached to a frame of a platform and can be suitably provided on or attached to any suitable structure of a platform. In addition, throughout this disclosure, a component or structure may be described as attached to another component or structure, but it will be understood that various components of the ladder assembly according to embodiments of the present disclosure can be formed as monolithic or unitary structures.

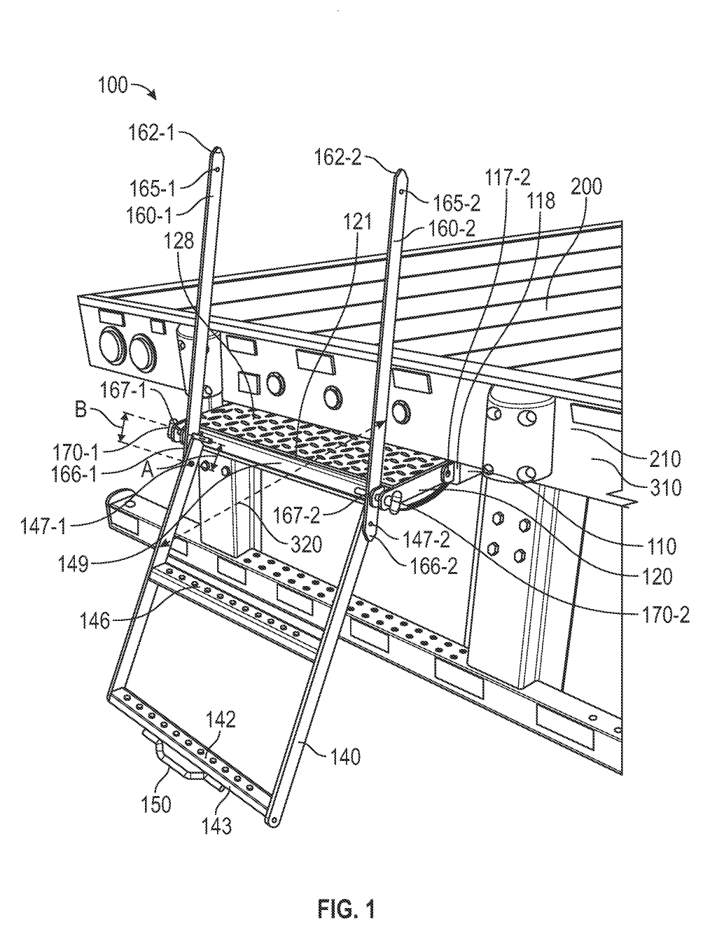

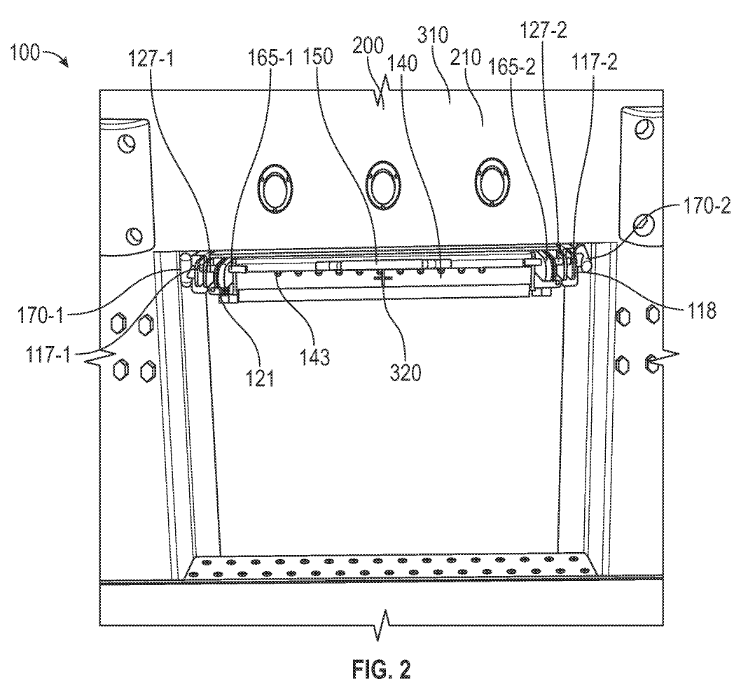

FIGS. 1 and 2 illustrate views of an example storable ladder assembly 100 according to an embodiment of the present disclosure. The ladder assembly 100 is attached to a flatbed 200 of a trailer. The flatbed 200 includes a rear surface 210. While reference to the rear surface 210 of a flatbed 200 is made herein in describing the location of the ladder assembly 100 and the components of the ladder assembly 100, it will be understood that the ladder assembly 100 can be positioned along other frame members of the flatbed 200, for example, a side frame or a front frame, or on a platform other than a flatbed. The ladder assembly 100 also includes a longitudinal axis 320. The rear surface 210 defines a plane 310 which is orthogonal to the longitudinal axis 320. As described herein, the plane 310 is oriented such that the flatbed 200 is forward of the plane 310.

The ladder assembly 100 can be transitioned between two states, a “deployed” state (for example, a deployed position) and a “stored” state (for example, a stowed state, or a stowed position). The ladder assembly 100 includes a support frame 110 which attaches to the flatbed 200. In this non-limiting embodiment, the support frame 110 attaches to the underside of the flatbed 200. The support frame 110 includes a front end (not visible in FIG. 1) and a rear end 118. When attached to the flatbed 200, the front end of the support frame 110 is forward of the plane 310 and the rear end 118 may extend as little as about 1 to 2 inches beyond the plane 310. Other distances are possible. The ladder assembly 100 also includes a step frame 120 inset within the support frame 110. The step frame 120 includes a front end (not visible in FIG. 1), a rear end 121, and a step 128 positioned at the rear end 121 and extending along the longitudinal axis 320 towards the front end of the step frame 120. The ladder assembly 100 also includes a ladder frame 140 configured to be inset within the step frame 120. The ladder frame 140 includes a front end 149 and a rear end 143. The ladder assembly 100 can also optionally include a handle 150 positioned at the rear end 143 of the ladder frame 140.

The ladder assembly 100 can optionally include a left handrail 160-1 and a right handrail 160-2 pivotally attached to the ladder frame 140. The ladder assembly 100 can also include a left lock pin 170-1 and a right lock pin 170-2. The left lock pin 170-1 and/or right lock pin 170-2 can be configured to fix the relative positions of the ladder frame 140, the left handrail 160-1, the right handrail 160-2, and the step frame 120 in both the deployed state and the stored state. In the stored state, the left lock pin 170-1 and/or the right lock pin 170-2 can also be configured to fix the relative positions of the ladder frame 140, the left handrail 160-1, the right handrail 160-2, and the step frame 120 relative to the support frame 110. Advantageously, the same lock pins 170-1 and 170-2 can be used to fix relative positions of components of the ladder assembly 100 in both the deployed and the stored states. The lock pins 170-1 and 170-2 can be attached to a lanyard or other connector attached to the support frame 110, thereby allowing the lock pin to be flexibly transitioned to lock different components in the deployed and stored states without losing the lock pins 170-1 and/or 170-2.

FIG. 1 illustrates an example of the ladder assembly 100 in a deployed state. In the deployed state, the step frame 120 is nested within the support frame 110. For example, the step frame 120 can be partially nested within the support frame 110 when the ladder assembly is in the deployed state. In non-limiting embodiments of the present disclosure, sides of the step frame 120 form a plane which is parallel to a plane formed by sides of the support frame 110. The step frame 120 is configured to translate along the longitudinal axis 320 so that the step 128 is positioned rearward of the plane 310. The translation of the step frame 120 along the longitudinal axis 320 may be limited by stops on the support frame 110. The stops can inhibit the step frame 120 from disengaging from the support frame 110 and/or prevent the step frame 120 from translating along the longitudinal axis 320 beyond a certain point. Many different stops and other types of locking mechanisms can be suitably implemented. The ladder frame 140 is configured to translate along the longitudinal axis 320 so that the ladder frame 140 is positioned rearward of the plane 310, the front end 149 is adjacent to the rear end 121 of the step frame 120, and the ladder frame 140 is positioned to allow a user to climb up or climb down the ladder assembly 100. In the deployed state, the ladder frame 140 can be positioned at an angle relative to the longitudinal axis 320, including but not limited to about a 90° angle, a 100° angle, a 110° angle, a 120° angle, a 130° angle a 135° angle, a 140° angle, a 145° angle, or a 150° angle, or any value or range defined by any of the preceding values. Other angles can be suitably implemented.

The left handrail 160-1 connects to the ladder frame 140 at a left pivot aperture 147-1 with a connection element (for example, a pin, bolt, screw, or another means of pivotal attachment) that is configured to allow the left handrail 160-1 to rotate relative to the ladder frame 140 about the left pivot aperture 147-1. In this example, a first end 166-1 of the left handrail 160-1 is connected to the ladder frame 140 at the left pivot aperture 147-1. A second end 162-1 of the left handrail 160-1 is positioned above the first end 166-1 to assist or support a user using the ladder assembly 100. The left pivot aperture 147-1 is positioned a distance away from the front end 149 of the ladder frame 140. The right handrail 160-2 connects to the ladder frame 140 with a right pivot aperture 147-2 with a connection element that is configured to allow the right handrail 160-2 to rotate relative to the ladder frame 140 about the right pivot aperture 147-2. In this example, a first end 166-2 of the right handrail 160-2 is connected to the ladder frame 140 at the right pivot aperture 147-2. A second end 162-2 of the right handrail 160-2 is positioned above the first end 166-2 to assist or support a user using the ladder assembly 100. The right pivot aperture 147-2 is positioned a distance away from the front end 149 of the ladder frame 140. The left and right handrails 160-1 and 160-2 are configured to be pivoted about the pivot apertures 147-1, 147-2 between a deployed position illustrated in FIG. 1 and a stowed position (for example, a stored state) discussed below with reference to FIG. 2.

The left handrail 160-1 includes a left through-hole 167-1 which is located on the left handrail a distance away from the left pivot aperture 147-1. In the deployed state, a lock pin 170-1 extends through a left step frame through-hole 127-1 of the step frame 120 and through the through-hole 167-1. In the deployed state, the lock pin 170-1 is configured to lock the left handrail 160-1 in the deployed position while simultaneously locking the ladder frame 140 at a defined angle relative to the step frame 120. The right handrail 160-2 includes a right through-hole 167-2 which is positioned along the right handrail 160-2 a distance away from the right pivot aperture 147-2. In the deployed state, a lock pin 170-2 extends through a right step frame through-hole 127-2 of the step frame 120 and through the through-hole 167-2. In the deployed state, the lock pin 170-2 is configured to lock the right handrail 160-2 in the deployed position while simultaneously locking the ladder frame 140 at a defined angle relative to the support frame 110. The distance between the left pivot aperture 147-1 and the front end 149 of the ladder frame 140 is labeled distance A. Distance A can be substantially the same distance as the distance between the right pivot aperture 147-2 and the front end 149 of the ladder frame 140. The distance between the left through-hole 167-1 and the left pivot aperture 147-1 is labeled distance B. Distance B can be substantially the same as the distance between the through-hole 167-2 and the pivot aperture 147-2.

The angle of the ladder frame 140 relative to the step frame 120 can be defined by distance A and distance B. For example, the greater distance B is, the closer the ladder frame 140 is to vertical when in the deployed state. In another example, the greater distance A is, the closer the ladder frame 140 is to horizontal when in the deployed state.

The ladder frame 140 includes a first step 142 and a second step 146. The first step 142 is positioned adjacent to the rear end 143. In some examples, in the deployed state, the first step 142 is positioned above the ground or other surface. In some examples, in the deployed state, the first step 142 contacts or is positioned on the ground or other surface. The second step 146 is positioned above the first step 142 in the deployed position. A handle 150 can be positioned at the rear end 143 of the ladder frame 140, for example below the first step 142. The handle 150 can be used to assist in moving the ladder assembly from the deployed state to the stored state, and from the stored state to the deployed state.

FIG. 2 illustrates an example of the ladder assembly 100 in a stored state. In the stored state, the step frame 120 is nested within the support frame 110. For example, the step frame 120 can be substantially or completely nested within the support frame 110 when the ladder assembly is in the stored state. In non-limiting embodiments of the present disclosure, sides of the step frame 120 form a plane in or parallel to a plane formed by sides of the support frame 110. The left and right handrails 160-1 and 160-2 can be positioned parallel to left and right sides of the ladder frame 140. In the stored state, the ladder frame 140 can be nested within the step frame 120. For example, the ladder frame 140 can be substantially or completely nested within the step frame 120 when the ladder assembly is in the stored state. In non-limiting embodiments of the present disclosure, a plane defined by sides of the ladder frame 140 is in or parallel to a plane defined by sides of the step frame 120. In the stored state, substantially all of the ladder assembly 100 can be positioned forward of the plane 310.

The support frame 110 includes a left side support through-hole 117-1 positioned at the rear end 118 of the support frame 110. The lock pin 170-1 passes through the support through-hole 117-1, through the left step frame through-hole 127-1, and through a second left handrail through-hole 165-1 positioned at a second end 162-1 of the left handrail 160-1. The support frame 110 includes a right support through-hole 117-2 positioned at the rear end 118 of the support frame 110. The lock pin 170-2 passes through the support through-hole 117-2, through the right step frame through-hole 127-2, and through a second right handrail through-hole 165-2 positioned at the second end 162-1 of the right handrail 160-2. In the stored state, the lock pin 170-2 locks the right handrail 160-2 to the support frame 110 and/or the lock pin 170-2 locks the right handrail 160-2 to the support frame 110, thereby holding the ladder assembly 100 in the stored state.

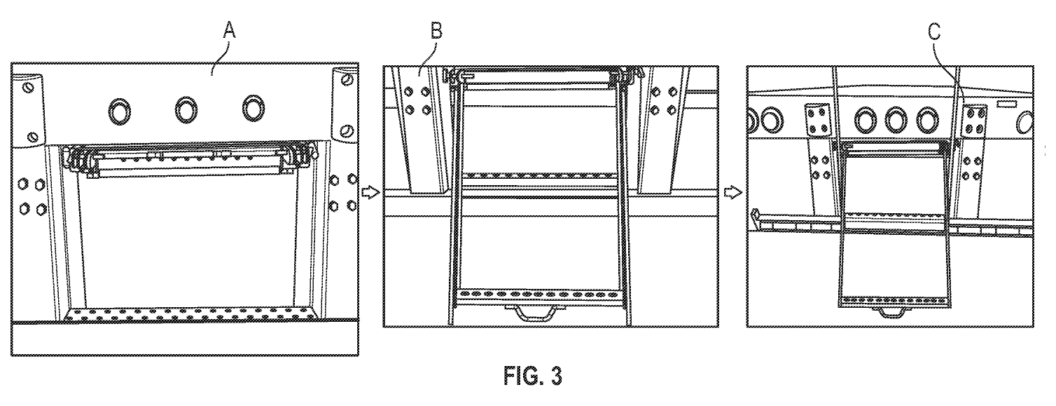

FIG. 3 illustrates deployment of the storable ladder assembly 100 from the stored state to the deployed state in accordance with one embodiment of the present disclosure. In box A, the ladder assembly 100 is in a stored state, for example as described above with reference to FIG. 2. In box B, the ladder assembly 100 is between the stored and deployed states. Portions of the step frame 120 and all of the ladder frame 140 have been translated rearward of the plane 310 and the ladder frame 140 has pivoted to the deployed position. In order to translate the ladder frame relative to the step frame and the step frame relative to the support frame, the lock pins 170-1 and 170-2 have been disengaged from their stored state. Then, the lock pins 170-1 and 170-2 can optionally be re-engaged into their deployed states to lock the ladder frame in position relative to the step frame. In box C, the ladder assembly 100 is in the deployed state, for example as described above with reference to FIG. 1. The handrails 160-1 and 160-2 have been pivoted into the deployed position and the lock pins 170-1 and 170-2 have been engaged into their deployed states.

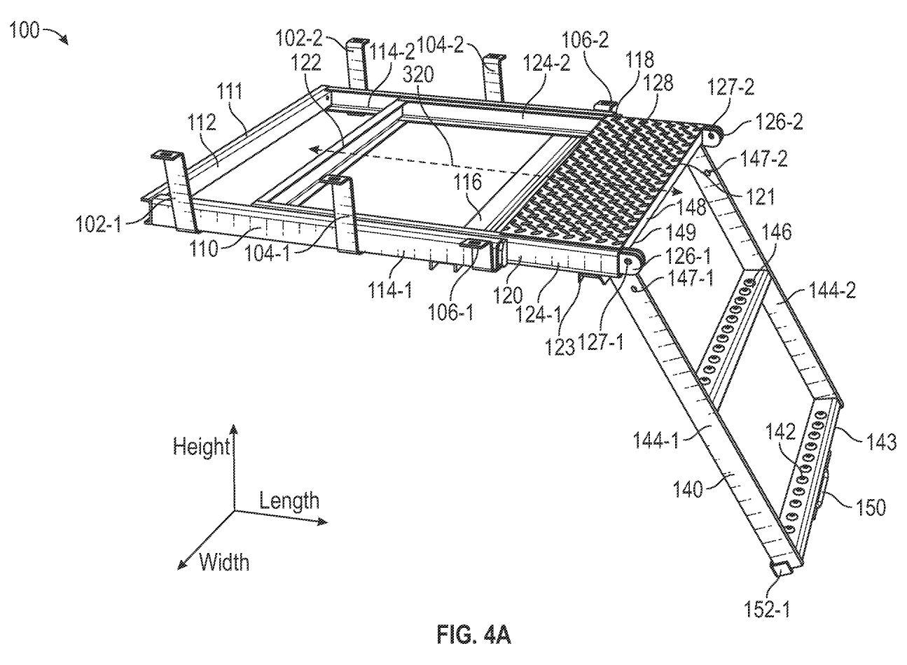

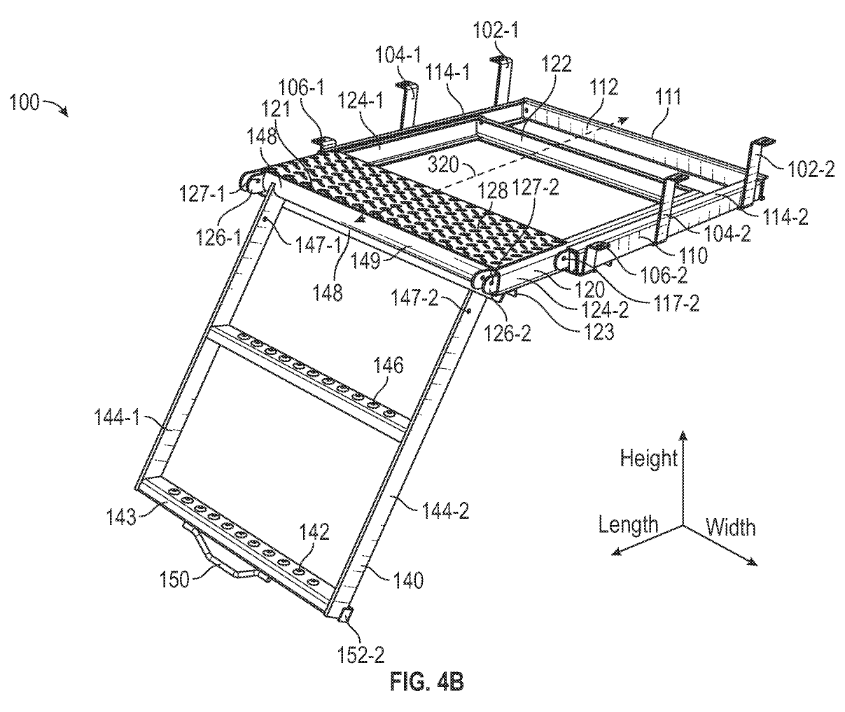

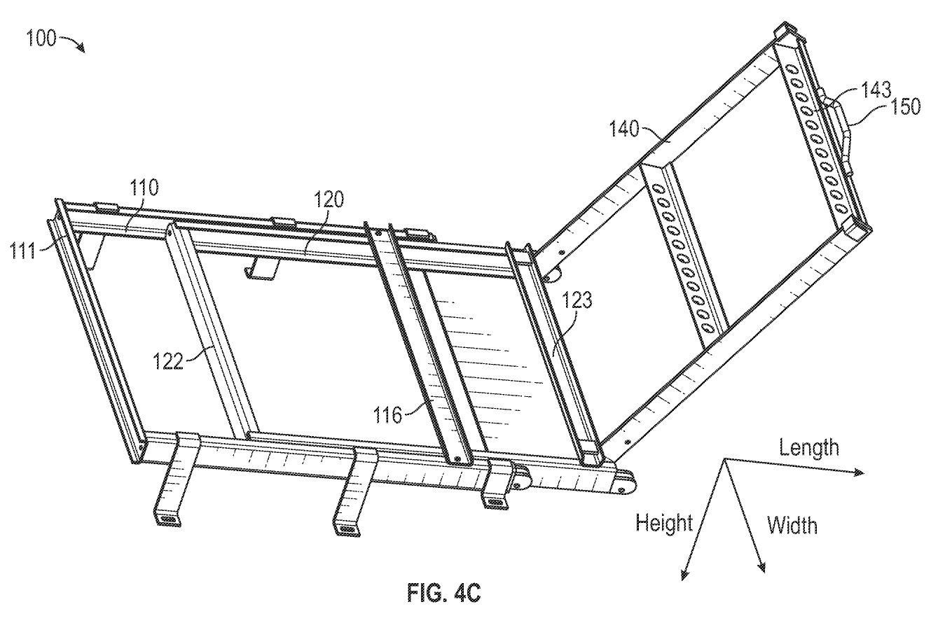

FIGS. 4A-4C illustrate perspective views of an example of a ladder assembly 100 according to an embodiment of the present disclosure. The ladder assembly 100 includes a support frame 110, a step frame 120 having portions that are inset within the support frame 110, and a ladder frame 140 having a pivot beam 148 positioned at a front end 149 of the ladder frame 140. Components of the ladder assembly 100 described herein can be formed from steel, stainless steel, galvanized steel, aluminum, a high strength composite material, or any other suitable material.

In some examples, the support frame 110 can include a front rail 112 positioned at a front end 111 of the support frame 110. The front end 111 can attach at a left end to a left support side rail 114-1 and at a right end to a right support side rail 114-2. As described herein, forward is towards the front end 111 and rearward is away from the front end 111. One or more stability rails 116 can attach between the bottom side of the left support side rail 114-1 and the bottom side of the right support side rail 114-2. The front rail 112 can be a C-beam, an I-beam, a rectangular beam, or any other suitable structure. The left support side rail 114-1 can be a C-beam. The left support side rail 114-1 can include a channel. The left support side rail 114-1 can include a c-shaped channel. The channel can face toward the right support side rail 114-2. Other structures can be suitably implemented. The right support side rail 114-2 can be a C-beam. The right support side rail 114-2 can include a channel. The right support side rail 114-2 can include a c-shaped channel. The channel can face toward the left support side rail 114-1. Other structures can be suitably implemented. The stability rails 116 can provide structural support to the side rails 114-1 and 114-2. The stability rails can be a C-beam, an I-beam, a rectangular beam, or any other suitable structure.

Attachments brackets can be provided to attach or mount the ladder assembly 100 to a platform, in this example a flatbed trailer. In this non-limiting embodiment, three attachment brackets can attach to the outside of the left support side rail 114-1. The first left attachment bracket 102-1 can be positioned closest to the front rail 112. The second left attachment bracket 104-1 can be positioned rearward from the first left attachment bracket 102-1 towards a midpoint of the left support side rail 114-1. The third left attachment bracket 106-1 can be positioned near the rear end 118. It will be understood that the attachment brackets are not limited to these positions and can be suitably implemented in other configurations. Three attachment brackets can attach to the outside of the right support side rail 114-2. The first right attachment bracket 102-2 is positioned closest to the front rail 112. The second right attachment bracket 104-2 is positioned rearward from the first right attachment bracket 102-2 towards a midpoint of the right support side rail 114-2. The third right attachment bracket 106-2 is positioned near rear end 118. It will be understood that the attachment brackets are not limited to these positions and can be suitably implemented in other configurations. The right support side rail 114-2 can be symmetrical with the left support side rail 114-1. The attachment brackets 102-1, 102-2, 104-1,104-2, 106-1, and 106-2 can have a z-shape where a bottom end of each attachment bracket is connected to the underside of the rail 114-1, 114-2. Each attachment bracket can extend upward and include an attachment end which extends along the width of the ladder assembly 100 away from the side rail 114-1 or 114-2. In some examples, the first attachment brackets 102-1 and 102-2 are taller (for example, extend further upward) than the other attachment brackets. In some examples, the first attachment brackets 102-1 and 102-2 and the second attachment brackets 104-1 and 104-2 are the same height (for example, each extends the same length upward). In some examples, the third attachment brackets 106-1 and 106-2 are shorter (for example, do not extend as far upward) than the other attachment brackets. In some examples, the attachment brackets can be customized depending on the truck bed, flatbed trailer, trailer, or other structure to which the ladder assembly 100 is attached.

The step frame 120 can be nested inside the support frame 110. The step frame 120 can be configured to translate along the longitudinal axis 320. The step frame 120 can include a front step rail 122 which can attach at a left end to a left step side rail 124-1 and at a right end to a right step side rail 124-2. A step 128 can be positioned between the left support side rail 114-1 and the right support side rail 114-2 at the rear end 121. A left step frame through-hole 127-1 can be positioned at the rear end 121 of the left step side rail 124-1. A right step frame through-hole 127-2 can be positioned at the rear end 121. The through-hole 127-1 can be arranged to pass horizontally or substantially horizontally through two ears or flanges 126-1 positioned at the rear end 121. The through-hole 127-2 can be arranged to pass horizontally or substantially horizontally through two ears or flanges 126-2 positioned at the rear end 121. A step stability rail 123 can attach between the bottom side of the left step side rail 124-1 and the bottom side of the right step side rail 124-2. The front step rail 122 can be a C-beam, an I-beam, a rectangular beam, or any other suitable structure. The left step side rail 124-1 can be a C-beam. The left step side rail 124-1 can include a channel. The left step side rail 124-1 can include a c-shaped channel. The channel can face toward the right step side rail 124-2. Other structures can be suitably implemented. The right step side rail 124-2 can be a C-beam. The right step side rail 124-2 can include a channel. The right step side rail 124-2 can include a c-shaped channel. The channel can face toward the left step side rail 124-1. Other structures can be suitably implemented. The step 128 can provide structural support to the side rails 124-1 and 124-2. The step 128 can be a rectangular, flat platform that can support a load, such as a human. The step 128 can include a tread plate pattern to provide grip while a user ascends and descends the ladder assembly 100.

The left step side rail 124-1 can nest in the c-shaped channel of the left support side rail 114-1 and the right step side rail 124-2 can nest in the c-shaped channel of the right support side rail 114-2. The left support side rail 114-1 and the right support side rail 114-2 can support the step frame 120. The step frame 120 can translate along the longitudinal axis 320. The step frame 120 can reversibly slide along the longitudinal axis 320. In the stored state, the front step rail 122 can contact the front rail 112. In the deployed state, as illustrated in FIGS. 4A and 4B, the front step rail 122 is spaced a distance rearward from the front rail 112. The left support side rail 114-1 and right support side rail 114-2 can include stops interior to the c-shaped channel which can limit how far rearward the step frame 120 can slide relative to the support frame 110. In some examples, the stops are configured to limit how far rearward the step frame 120 can slide relative to the support frame 110 while also being configured to not limit translation of the step frame 120 in the forward direction relative to the support frame 110.

The ladder frame 140 can attach to the step frame 120. The ladder frame 140 can include a first step 142 positioned between a left ladder side rail 144-1 and a right ladder side rail 144-2 at or substantially at the rear end 143. A second step 146 can be positioned between the left ladder side rail 144-1 and the right ladder side rail 144-2. The second step 146 can be positioned near the midpoint along the length of the left ladder side rail 144-1 and right ladder side rail 144-2. The ladder frame 140 includes a pivot beam 148 positioned between the left ladder side rail 144-1 and the right ladder side rail 144-2. The pivot beam 148 can be positioned at or substantially at the front end 149 of the ladder frame 140.

The first step 142 can have a rectangular shape and a flat or substantially flat top surface. The second step 146 can have a rectangular shape and a flat or substantially flat top surface. In some examples, the top surface of the first step 142 and/or the second step 146 includes grip features such as raised circular treads. The first step 142 can be parallel to the second step 146. The first step 142 and second step 146 can be angled relative to the left ladder side rail 144-1 and right ladder side rail 144-2 so that in the deployed state, the first step 142 and second step 146 are substantially parallel to the ground or other surface. The first step 142 and second step 146 can be welded to the left ladder side rail 144-1 and the right ladder side rail 144-2. In some examples, in the deployed state, the first step 142 and the second step 146 can support loads between about 300 and 700lbs. Other load ratings can be suitably implemented.

The left ladder side rail 144-1 and the right ladder side rail 144-2 can each be a rectangular slat. The pivot beam 148 can be cylindrical. Ends of the pivot beam 148 can nest within the left step side rail 124-1 and the right step side rail 124-2. A handle 150 can be positioned on a bottom surface of the first step 142 at the rear end 143 of the ladder frame 140.

While the left and right handrails described above with reference to FIGS. 1 and 2 are not shown in FIGS. 4A or 4B, a left handrail support 152-1 and a right handrail support 152-2, and a left pivot aperture 147-1 and a right pivot aperture 147-2 are shown in FIGS. 4A and 4B. The left handrail support 152-1 can be a hook positioned on the outside of the left ladder side rail 144-1 and the right handrail support 152-2 can be a hook positioned on the outside of the right ladder side rail 144-2. The left handrail support 152-1 and the right handrail support 152-2 can support or hold the left and right handrails in place in a stored state.

The ends of the pivot beam 148 can be sized and shaped to nest in the c-shaped channel of the right step side rail 124-2 and the c-shaped channel of the left step side rail 124-1. The cylindrical shape of the pivot beam 148 can allow the pivot beam 148 to rotate within the c-shaped channels of the right step side rail 124-2 and the left step side rail 124-1. The pivot beam 148 can also translate or reversibly slide along the longitudinal axis 320. The step stability rail 123 can support the left ladder side rail 144-1 and the right ladder side rail 144-2 when ladder frame 140 translates along the longitudinal axis 320. In the stored state, the pivot beam 148 can contact the front step rail 122.

To move from the deployed state illustrated in FIGS. 1, 4A, and 4B to a stored state as illustrated in FIG. 2, the handle 150 can be lifted to pivot the ladder frame 140 into a horizontal position parallel to the step frame 120 and the support frame 110. Once the ladder frame is parallel to the step frame 120, the handle 150 can be moved, for example pushed forward, toward the flatbed 200 so that the ladder frame 140 translates forward along the longitudinal axis 320 towards the front step rail 122 of the step frame 120, and the support frame 110 translates forward along the longitudinal axis 320 towards the front rail 112 of the support frame 110 until the ladder assembly 100 has reached the stowed state (for example, the stored state) described above (for example, to a state where the left ladder side rail 144-1 and right ladder side rail 144-2 of the ladder frame 140 are fully nested within the step frame 120 and the left step side rail 124-1 and right step side rail 124-2 of the step frame are fully nested within the support frame 110). The unlocking of stops or other locking mechanisms can be performed at any suitable time in the above-described process.

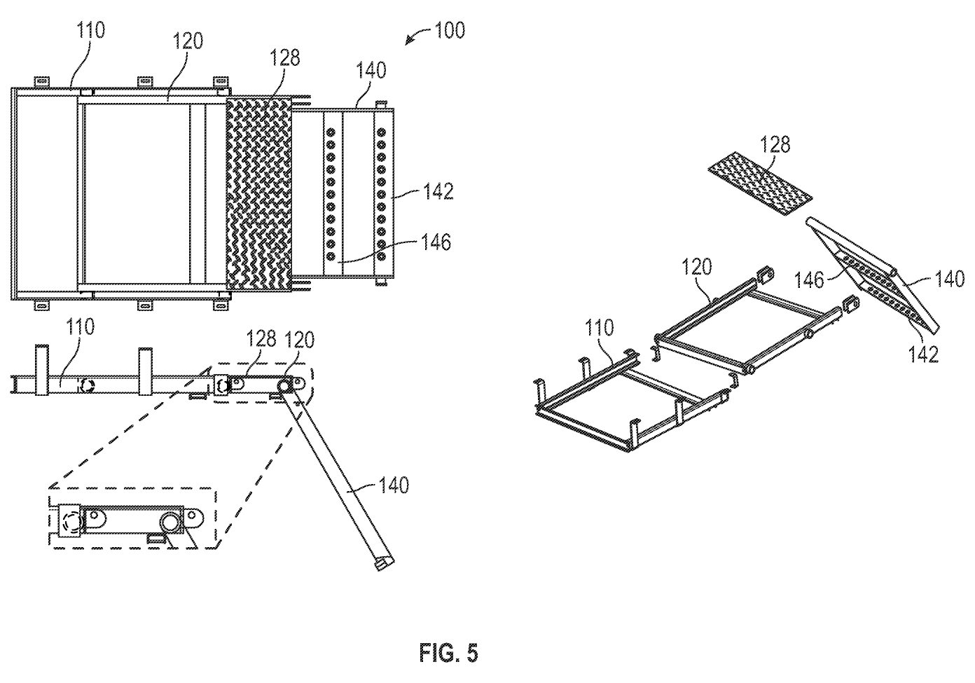

FIG. 5 illustrates top, side, detailed section, and exploded views of various components of the ladder assembly 100 according to the present disclosure.

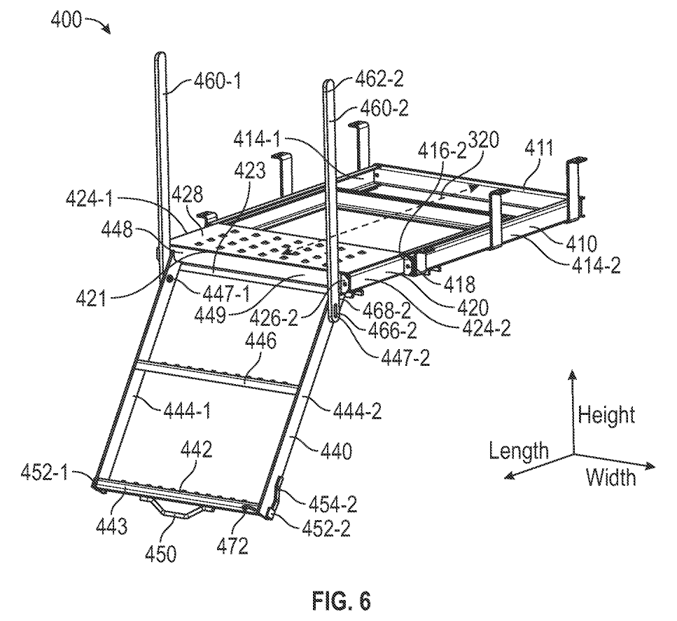

FIG. 6 illustrates a perspective view of an embodiment of a storable ladder assembly 400 according to the present disclosure in a deployed state. The features described below in connection with the ladder assembly 400 may be provided instead of or in addition to any of the various features described in connection with ladder assembly 100. The ladder assembly 400 includes a support frame 410 having a front end 411 and a rear end 418, a step frame 420 having portions that are inset within the support frame 410, and a ladder frame 440 having a pivot beam 448 positioned at a forward end 449 of the ladder frame 440. Components of the ladder assembly 400 described herein can be formed from steel, stainless steel, galvanized steel, aluminum, a high strength composite material, or any other suitable material.

The support frame 410 includes a left support side rail 414-1 and a right support side rail 414-2 forming a plane. The step frame 420 is configured to reversibly slide in the plane of the support frame 410 between the left support side rail 414-1 and the right support side rail 414-2. The step frame 420 includes a left step side rail 424-1, a right step side rail 424-2, and a step 428 between the left step side rail 424-1 and the right step side rail 424-2. The ladder frame 440 includes a pivot beam 448 configured to reversibly slide in the plane of the support frame 410 between the left step side rail 424-1 and the right step side rail 424-2 of the step frame 420. The pivot beam 448 is further configured to rotate relative to the plane of the support frame 410. The ladder frame 440 further includes a left ladder side rail 444-1, a right ladder side rail 444-2, and one or more steps 442, 446 positioned between the left ladder side rail 444-1 and the right ladder side rail 444-2. The ladder assembly can include one or more handrails 460-1, 460-2 configured to rotate relative to the ladder frame 440 between a stored state and a deployed state. As described in more detail below, the one more handrails 460-1, 460-2 can include a slotted opening configured to rotate about and translate relative to a connection element received in the ladder frame 440.

The support frame 410 can include a right end plate 416-2 attached to the end of the right support side rail 414-2. The support frame 410 can include a left end plate attached to the end of the left support side rail 414-1. The right end plate 416-2 can be perpendicular to the right support side rail 414-2. The left end plate can be perpendicular to the left support side rail 414-1.

The step frame 420 can include a right end plate 426-2 attached to the end of the right step side rail 424-2. The step frame 420 can include a left end plate attached to the end of the left step side rail 424-1. The right end plate 426-2 can be perpendicular to the right step side rail 424-2 The left end plate can be perpendicular to the left step side rail 424-1.

A step stability rail 423 can attach between a bottom side of the left step side rail 424-1 and a bottom side of the right step side rail 424-2. A rearmost surface of the step stability rail 423 can be bent at an angle between 0 degrees and 90 degrees relative to a top surface of the step frame 420. The rearmost surface of the step stability rail 423 can contact the left ladder side rail 444-1 and the right ladder side rail 444-2 when the ladder frame 440 is in the deployed position. The angle of that rearmost surface can establish the angle of the ladder frame 440 relative to the longitudinal axis 320 of the ladder 400 when the ladder 400 is in the deployed state.

The ladder frame 440 includes a first step 442 and a second step 446. The first step 442 is positioned adjacent to a rear end 443 of the ladder frame 440. In some examples, in the deployed state, the first step 442 is positioned above the ground or other surface. The second step 446 is positioned above the first step 442 in the deployed position. A handle 450 can be positioned at the rear end 443 of the ladder frame 440, for example below the first step 442. The handle 450 can be used to assist in moving the ladder assembly from the deployed state to the stored state, and from the stored state to the deployed state. A retainer 472 can be positioned on the first step 442 of the ladder frame 440, for example on an upward surface of the first step 442. The retainer 472 can be positioned to the right of the handle 450. The ladder frame 440 also includes a left pivot aperture 447-1 and a right pivot aperture 447-2, which can be through holes through which a fastener or other connection element can pass.

The ladder assembly can optionally include a left handrail 460-1 and a right handrail 460-2 pivotally attached to the ladder frame 440. The ladder assembly 400 can include a left handrail support 452-1 and a right handrail support 452-2. The left handrail support 452-1 and right handrail support 452-2 can be at the rear end 443 of the ladder frame 440. The left handrail support 452-1 can be a hook positioned on the outside surface of the left ladder side rail 444-1. The hook of the left handrail support 452-1 can be a L-bracket attached to the outside surface of the ladder frame 440, such that the left handrail support 452-1 and the outside surface of the ladder frame 440 form a U-shaped opening. The right handrail support 452-2 can be a hook positioned on the outside surface of the right ladder side rail 444-2. The hook of the right handrail support 452-2 can be a L-bracket attached to the outside surface of the ladder frame 440, such that the right handrail support 452-2 and outside surface of the ladder frame 440 form a U-shaped opening. The left handrail support 452-1 can include a support 454-1 (not shown) and the right handrail support 452-2 can include a support 454-2. The support 454-2 can attach to the outer surface of the U-shaped opening of the right handrail support 452-2. The support 454-2 can advantageously increase the structural strength of the right handrail support 452-2. The support 454-2 can include a portion parallel to the right ladder side rail 444-2 which can be welded to the right ladder side rail 444-2. The support 454-2 can include a portion which can attach to the right handrail support 452-2. The left handrail support 452-1 and the right handrail support 452-2 can support or hold the left and right handrails in place in a stored state. The support 454-1 can include some or all of the features of the support 454-2.

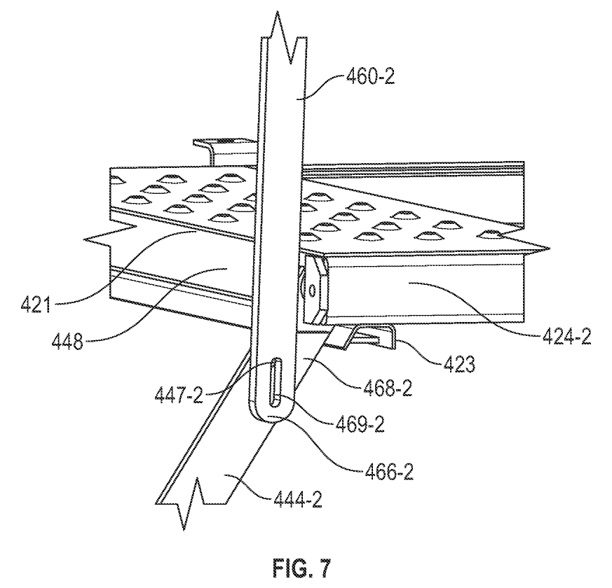

FIG. 7 illustrates a detailed view of the right handrail 460-2 of the storable ladder assembly 400 according to an embodiment of the present disclosure. The left handrail 460-1 can include some or all of the features described herein with regard to the right handrail 460-2. The right handrail 460-2 can include a slotted opening 469-2. The slotted opening 469-2 can extend from a first end 466-2 of the right handrail 460-2 toward a second end 462-2. The right handrail 460-2 connects to the ladder frame 440 at a right pivot aperture 447-2 with a connection element (for example, a pin, bolt, screw, or another means of pivotal attachment). The connection element can be configured to allow the right handrail 460-2 to rotate relative to the ladder frame 440 about the right pivot aperture 447-2. The connection element can attach the slotted opening 469-2 to the right pivot aperture 447-2.

The right handrail 460-2 can include a stop 468-2. The right ladder side rail 444-2 can include the stop 468-2. The stop 468-2 can fix the position of the right handrail 460-2 in the deployed state. The stop 468-2 can be a triangular plate. The stop 468-2 is configured to contact the forward side of the right handrail 460-2 when the right handrail 460-2 is in the deployed state. When the connection element is positioned at the top of the slotted opening 469-2, the stop 468-2 can prevent clockwise rotation of the handrail 460-2, thereby locking the handrail 460-2 in the upright position illustrated in FIG. 7. The rearmost surface of the stop 468-2 can contact the forwardmost surface of the handrail 460-2. The contact between the rearmost surface of the stop 468-2 and the forwardmost surface of the handrail 460-2 can advantageously prevent rotation of the handrail 460-2 in the clockwise direction. Simultaneously, the contact between the rearmost surface of the stop 468-2 and the forwardmost surface of the handrail 460-2 can advantageously prevent rotation of the handrail 460-2 in the counterclockwise direction. The stop 468-2 can be positioned below the right step side rail 424-2 when the ladder frame 440 is in the deployed state. The stop 468-2 can be positioned at least partially forward of the rear end 421 of the step frame 420.

The slotted opening 469-2 can advantageously allow for the right handrail 460-2 to clear the stop 468-2 when pivoting from the deployed state to the stored state. A user can pull up on the right handrail 460-2 so that the connection element on the right ladder side rail 444-2 can move downward relative to the slotted opening 469-2. This position of the right handrail 460-2 can provide clearance for the first end 466-2 to clear the stop 468-2. The handrail 460-2 cannot rotate in the counterclockwise direction to move to the stored position until the user pulls up on the handrail 460-2 a distance, for example, the length of the slotted opening 469-2, sufficient to allow the bottom of the handrail 460-2 to clear the stop 468-2 and rotate unobstructed by the stop 468-2.

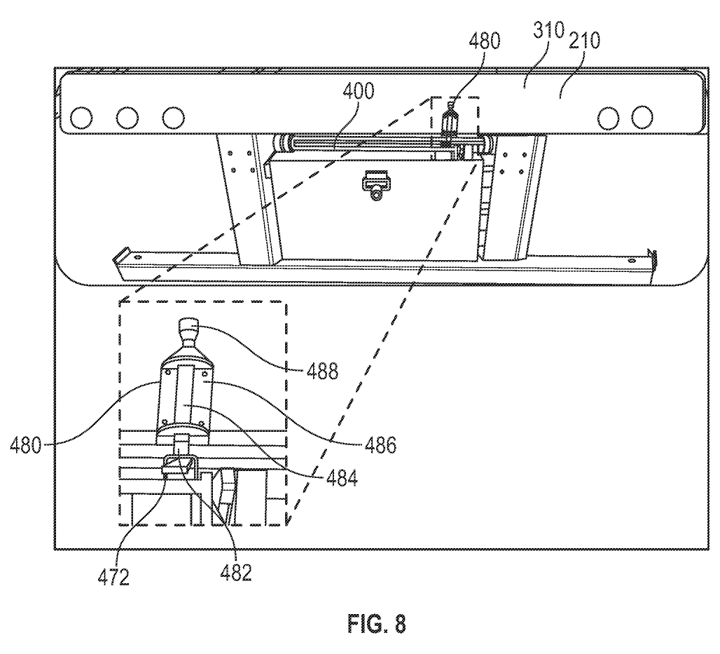

FIG. 8 illustrates a perspective view of an embodiment of the ladder assembly 400 attached to a flatbed trailer 200 in a stored state according to an embodiment of the present disclosure. In the stored state, substantially all of the ladder assembly 400 can be positioned forward of the plane 310. A latch 480 can hold the ladder assembly 400 in a closed position on the flatbed 200. The latch 480 and storable ladder assembly 400 can form a kit which can be installed on a flatbed 200.

The latch 480 can be provided on the rear surface 210. The latch 480 can be attached to the rear surface 210. The latch 480 can be configured to secure the ladder in the stowed stated (for example, the stored state). In some examples, the latch 480 can be a slam latch. In other examples, the latch 480 can be a clasp latch, a spring latch, a swinging latch, or another type of latch. The latch 480 can include an attachment body 486, a ramped end 482, a spring 484, and a handle 488. The retainer 472 of the ladder frame 440 can extend rearward from the plane 310 when the ladder assembly 400 is in the stored state. The latch 480 can engage the retainer 472 to lock the ladder assembly 400 in the stored state. The ramped end 482 can include a ramped face on a rearward side and have a flat face on a forward side. When transitioning from the deployed state to the stored state, the ladder frame 440 can be pushed forward. By pushing the ladder frame 440 forward, the retainer 472 can also travel forward. The retainer 472 can press against the ramped end 482, which can cause the ramped end 482 to translate upward within the attachment body 486 and compress the spring 484. Once the ramped end 482 is pushed upward, the retainer 472 can be positioned forward of the ramped end 482. The spring 484 can re-position the ramped end 482 against the retainer 472 to lock the ladder assembly 400 in the stored state. To release the ladder assembly 400 from the stored state and transition the ladder assembly 400 to the deployed state, the handle 488 can be pulled upward and the ladder assembly 400 pulled outward using the handle 450 of the ladder frame 440.

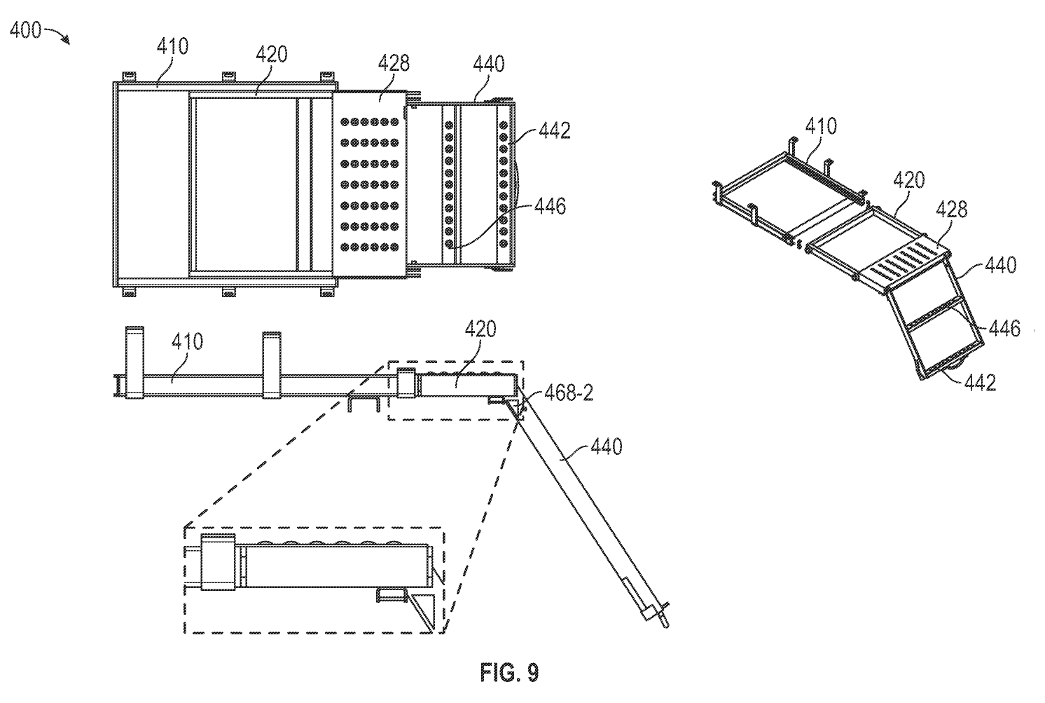

FIG. 9 illustrates top, side, detailed section, and exploded views of various components of the ladder assembly 400 according to the present disclosure.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

What is claimed is:

1. A storable ladder assembly configured to attach to an underside of a platform and transition between a stored state and a deployed state, the storable ladder assembly comprising:
a support frame comprising:
a left support side rail comprising a c-shaped channel,
a right support side rail comprising a c-shaped channel, and
a front rail attached at a left end to the left support side rail and at a right end to the right support side rail;
a step frame configured to reversibly slide in the c-shaped channels of the support frame, the step frame comprising
a left step side rail comprising a c-shaped channel,
a right step side rail comprising a c-shaped channel, and
a step between the left step side rail and the right step side rail; and a ladder frame comprising:
a left ladder side rail,
a right ladder side rail,
a pivot beam rotatably attached to the step frame and configured to reversibly slide in the c-shaped channels of the step frame, and
one or more steps positioned between the left ladder side rail and the right ladder side rail.

2. The storable ladder assembly of claim 1, further comprising a left handrail and a right handrail pivotally attached to the ladder frame and configured to pivot between a stored state and a deployed state, wherein the left handrail comprises a slotted opening configured to rotate about a connection element received in the left ladder side rail, and wherein the right handrail comprises a slotted opening configured to rotate about a connection element received in the right ladder side rail.

3. The storable ladder assembly of claim 2, wherein, when the right handrail is in the deployed state, a forwardmost surface of the right handrail is configured to contact a stop on the right ladder side rail, the stop configured to prevent clockwise and counterclockwise rotation of the right handrail.

4. The storable ladder assembly of claim 3, wherein the right handrail is configured to pivot from the deployed state to the stored state by moving the slotted opening of the right handrail upward relative to the connection element received in the right ladder side rail to a position where a lowermost surface of the right handrail is above the stop on the right ladder side rail, and rotating the right handrail parallel with the right ladder side rail.

5. The storable ladder assembly of claim 2, wherein, when the storable ladder assembly is in the stored state, the left handrail is received in the c-shaped channel of the left step side rail and the right handrail is received in the c-shaped channel of the right step side rail.

6. The storable ladder assembly of claim 1, wherein, when the storable ladder assembly is in the stored state, the step frame is nested within the support frame and the ladder frame is nested within the step frame.

7. The storable ladder assembly of claim 1, wherein, when the storable ladder assembly is in the deployed state, a rear end of the step frame is positioned rearward of a rear end of the support frame and the ladder frame is positioned at an angle relative to a longitudinal axis of the storable ladder assembly.

8. The storable ladder assembly of claim 1, wherein, when the storable ladder assembly is in the deployed state, each of the one or more steps of the ladder frame comprises a flat surface that is parallel to the step of the step frame.

9. The storable ladder assembly of claim 1, wherein the step frame comprises a step stability rail support attached between a bottom side of the left step side rail and a bottom side of the right step side rail at a rear end of the step frame, and wherein, when the storable ladder is in a deployed state, a front surface of the left ladder side rail and a front surface of the right ladder side rail contact a rear surface of the step stability rail support.

10. The storable ladder assembly of claim 1, wherein the ladder frame comprises a left handrail support positioned on an outside surface of the left ladder side rail and a right handrail support positioned on an outside surface of the right ladder side rail, wherein the left handrail support and the right handrail support are configured to support the left and right handrails, respectively, when the storable ladder assembly is in the stored state.

11. The storable ladder assembly of claim 1, further comprising a left handrail pivotally attached to the ladder frame and configured to pivot between a stored state and a deployed state, wherein the step frame comprises a left step frame through-hole at a rear end of the step frame, wherein the left handrail comprises a first left handrail through-hole a distance away from a first end of the left handrail, wherein in the deployed state a first lock pin can extend through the left step frame through-hole and the first left handrail through-hole, thereby locking the left handrail in a deployed position and locking the ladder frame at a defined angle relative to the step frame.

12. A storable ladder comprising:
a support frame comprising a left support side rail and a right support side rail forming a plane;
a step frame configured to reversibly slide in the plane of the support frame between the left support side rail and the right support side rail, the step frame comprising a left step side rail, a right step side rail, and a step between the left step side rail and the right step side rail;
a ladder frame comprising a pivot beam configured to reversibly slide in the plane of the support frame between the left step side rail and the right step side rail of the step frame, the pivot beam further configured to rotate relative to the plane of the support frame, the ladder frame further comprising a left ladder side rail, a right ladder side rail, and one or more steps positioned between the left ladder side rail and the right ladder side rail; and
a handrail configured to rotate relative to the ladder frame between a stored state and a deployed state, wherein the handrail comprises a slotted opening configured to rotate about and translate relative to a connection element received in the ladder frame.

13. The storable ladder of claim 12, wherein the handrail comprises a left handrail, wherein the left handrail is configured to translate along a longitudinal axis of the slotted opening between a first position relative to a left connection element received in the left ladder side rail and a second position relative to the left connection element, wherein, when the left handrail is in the first position, a forwardmost surface of the left handrail is configured to contact a stop on the left ladder side rail, the stop configured to prevent clockwise and counterclockwise rotation of the left handrail.

14. The storable ladder of claim 13, wherein the stop comprises a triangular plate.

15. The storable ladder of claim 14, wherein, when the left handrail is in the second position, a lowermost surface of the left handrail is above the stop such that the left handrail can pivot relative to the ladder frame.

16. The storable ladder of claim 14, further comprising a right handrail configured to translate along a longitudinal axis of the slotted opening between a first position relative to a right connection element received in the right ladder side rail and a second position relative to the right connection element, wherein, when the right handrail is in the first position, a forwardmost surface of the right handrail is configured to contact a stop on the right ladder side rail, the stop configured to prevent clockwise and counterclockwise rotation of the right handrail.

17. The storable ladder of claim 12, wherein the step frame comprises a step stability rail support attached between a bottom side of the left step side rail and a bottom side of the right step side rail at a rear end of the step frame, and wherein, when the storable ladder is in a deployed state, a front surface of the left ladder side rail and a front surface of the right ladder side rail contact a rear surface of the step stability rail support.

18. The storable ladder of claim 12, further comprising a left attachment bracket attached to the left support side rail and a right attachment bracket attached to the right support side rail, wherein the left and right attachment brackets are configured to mount the storable ladder to an underside of a vehicle.

19. The storable ladder of claim 12, further comprising a handle positioned at a rear end of the ladder frame.

20. A kit comprising:
the storable ladder of claim 12; and
a latch configured to secure the storable ladder in the stored state.
